(19) United States
(12) Patent Application Publication
(10) Pub. No.: US 2011/0214986 A1
(43) Pub. Date: Sep. 8, 2011

(54) Clean water and clean air project (brine): method of water treatment, chemical production, and underground energy storage

(76) Inventor: Michael Belford Brown, San Francisco, CA (US)

(21) Appl. No.: 12/660,941

(22) Filed: Mar. 8, 2010

(51) Int. Cl. C25B 9/00; H02K 7/18

(52) U.S. Cl. 204/276; 290/52

(57) ABSTRACT

An energy transport and storage system in combination with a method of water treatment which includes: a brine (including ocean, sea, or estuary water) interconnection, an electricity interconnection with an electric grid, a filtration and demineralization system, a brine water electrolyser, a gas separation or filtration system, a heat recovery system connected to the electrolyser, a sodium hydroxide recovery system, an interconnection to an alternative hydrogen gas supply, a high pressure underground hydrogen gas storage system, a safety valve connected to the underground hydrogen gas storage system, an electric generation system powered by compressed hydrogen gas turning a turbine during decompression, which can recycle electricity within the system or send electricity to an electric grid, a hydrogen gas outlet for distribution of hydrogen gas, a system to collect other gases, and a chlorine gas production system. This invention will produce clean water and clean air. This invention will provide clean water by using brine water to produce energy in the form of hydrogen, which is eventually converted back into fresh water, which can be used. Hydrogen gas produced from renewable energy can be combined with atmospheric oxygen to produce electricity, heat, and water. This energy creation and use process in the form of hydrogen creates virtually no pollution. This hydrogen energy use process is thus cleaner than the use of petroleum combustion technologies, which pollute air and water.

### BACKGROUND-PRIOR ART

The following is a tabulation of some prior art that presently appears relevant:

### U.S. Patent Application Publications

| Publication Nr. | Kind Code | Publ. Date | Applicant |
|---|---|---|---|
| 20070084718 | Al | 2007, Apr. 19 | Fleming |
| 20090282840 | Al | 2009, Nov. 19 | Chen, et. al. |
| 20090322090 | Al | 2009, Dec. 31 | Wolf |
| 20100009224 | Al | 2010, Jan. 14 | Ku, et. al. |
| 20090313896 | Al | 2009, Dec. 24 | Glidewell |
| 20100012504 | Al | 2010, Jan. 21 | Tonca |
| 20090272588 | Al | 2009, Nov. 05 | Ryu, et. al. |
| 20090283402 | Al | 2009, Nov. 19 | Osman |

### FIELD OF INVENTION

The present invention relates to an energy transport and storage system combined with a system of production of products for water treatment and industrial uses.

### BACKGROUND OF INVENTION

This invention contemplates a design where the water interconnection is brine. Brine can be seawater, salty estuary water, or ocean water. The invention will use brine, electricity, and possibly an alternative hydrogen source as inputs to the invention. This invention will use these inputs to: produce and store hydrogen gas underground, produce chlorine gas, which will be used for either water treatment or other industrial processes, and produce sodium hydroxide, which could be used for industrial processes.

The idea of using electrolysis or other processes to produce chlorine gas and sodium hydroxide is not unique. The idea of producing hydrogen gas as an energy source in not unique. However, this specific method of combining hydrogen gas storage and use with chlorine gas and sodium hydroxide is unique and beneficial to humanity.

First, this invention seeks to economically produce and store hydrogen gas. Hydrogen gas will be needed in large quantities at refineries as the demand for low-sulfur fuels increases, and as the “sweet” quality of the world's crude oil and petroleum production decreases. Sweet crude is less abundant now than it has been in the past. Refineries will likely need to refine large amounts of tar sand oil or heavy crude in the near future (which will contain larger amounts of sulfur). Most hydrogen is created by reforming natural gas or other petroleum products with, at most, eighty percent efficiency. This reformation process also releases a substantial amount of greenhouse gas, including carbon dioxide, into the air. Due to regulatory constraints, refineries may need to purchase hydrogen gas in large quantities from alternative sources. In the long-term, hydrogen gas may be created in large quantities for many reasons. These reasons include: 1. using hydrogen gas as a supplement or replacement for natural gas and other non-renewable petroleum products as a source of energy for mobile machines and devices, 2. chemical processing, including fertilizers, and 3. clean water creation.

There are many different methods of manufacturing hydrogen gas. Currently, the most economic method is natural gas reformation. This method uses natural gas, a non-renewable resource, and creates substantial amounts of greenhouse gases. There are other experimental processes, such as biological production, which could economically produce large amounts of hydrogen gas. This invention contemplates creating hydrogen primarily through electrolysis. However, this invention anticipates allowing for the compressed storage and distribution of hydrogen produced from other sources. This invention anticipates allowing compressed storage from the sources of natural gas reformation and biological production in conjunction with water treatment, but is not limited to theses sources.

Second, water treatment is an important and growing need in the United States and abroad. In many locations, fresh water is either not available or prohibitively expensive to obtain. This invention will use brine water, which is readily abundant on earth near a coastline. It will then produce chorine gas, which can be used to disinfect water and continue the disinfection of water through a water distribution system. This is because chlorine gas is a powerful disinfectant, which can be used in large scale water treatment plants and is effective in controlling biological contaminants in distribution pipes. This invention would ideally supply chlorine gas to a water treatment facility. Alternatively, chlorine gas could be used for production of other products including, but not limited to, plastics and biological compounds.

Third, this invention could also be used to create electricity and either reuse it or send the electricity onto an electric grid. The need for electric production and storage is likely to increase as the need for smart grid technologies increases and the world's dependence on nuclear power, which is necessarily generated at night, because nuclear generation plants are inefficient to shut down at night, increases. This need for electric production and storage is also likely to increase, as reliance on wind power or other unreliable and intermittent sources of electric generation increases. This invention will store and compress hydrogen underground. This invention will electrolyze water and compress the hydrogen underground, primarily during then ight, when excess wind or nuclear generated electricity is being produced. It will then decompress the hydrogen (generating electricity by turning a turbine when the hydrogen gas is decompressed) and then pump out the hydrogen, thud creating electricity during the day when the price for electricity is great.

Fourth, this invention will produce sodium hydroxide, which can be further refined or sent in rough form to be used in many different industrial processes or products.

### SUMMARY OF INVENTION

This invention anticipates the use of electrolysis of brine (seawater, salty estuary water, or ocean water) to produce electricity, hydrogen gas, chlorine gas, and sodium hydroxide. This invention also contemplates storing compressed hydrogen, created by electrolysis and other methods of hydrogen gas creation underground and generating electricity while decompressing hydrogen gas.

### BRIEF DESCRIPTION OF THE DRAWINGS

Further features, properties, and advantages of the present invention will become clear from the following description of embodiments in conjunction with the accompanying drawing. The described features are advantages alone and in combination with each other.

FIG. 1 schematically shows an inventive energy storage system in combination with a system of water production.

### DETAILED DESCRIPTION OF INVENTION

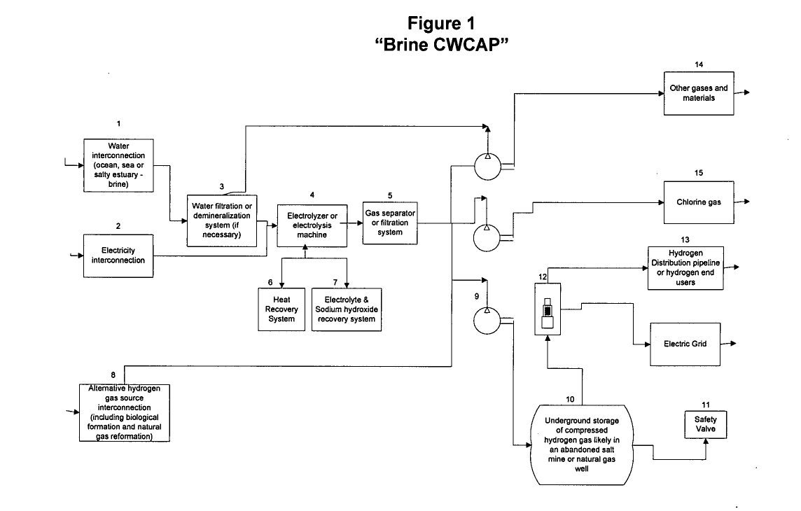

One embodiment of the present invention will now be described with reference to FIG. 1.

FIG. 1 is a detailed schematic drawing of the invention using brine water as an input. The arrows in the schematic drawing represent the flow of products within the invention. The numbered paragraphs below both correspond with and explain the numbered items in FIG. 1.

(1) This invention will import brine from an ocean, sea, or salty estuary. The brine will be pumped from an ocean, sea, or salt water estuary to the location of the invention. The intake to the brine pump will contain a fish screen to prevent fish and wildlife from entering the intake.
(2) This invention will import electricity from an electric grid or other power source or sources. The energy needs of this invention will be substantial. An electric transmission line interconnection of 50 to 500 kilovolts is anticipated.
(3) This invention may filter and de-mineralize the brine. The composition of incoming brine will differ in different project locations. Thus it may be necessary to filter out water contaminants, which are harmful to a brine water electrolysis process, which include, but are not limited to, magnesium, calcium, and methyl tertiary butyl ether.
(4) This invention will contain an electrolyser, which may be a high pressure electrolyser. This electrolyser will use electricity to power an anode and cathode, which will be exposed to the brine. This electrolyser will cause the brine to form chlorine gas, hydrogen gas, sodium hydroxide, and other gases and compounds.
(5) The gases produced by electrolysis (hydrogen, chlorine, and other gases) must be separated and compressed. The hydrogen gas will form near the cathode, and chlorine gas will form near the anode. Other gases may form as well. The composition of the other gases will depend on the composition of the water input into the invention.
(6) This invention includes a self-contained heat recovery system connected to the electrolyser. The heat will be used to facilitate electrolysis as shown in (4). Loss of heat is undesirable, because loss of heat will decrease the efficiency of the electrolysis process. Heat created in the electrolysis process will be recycled. The excess heat may be collected and used to heat incoming brine water to facilitate electrolysis of said brine water.
(7) This invention will regulate the use of electrolytes to facilitate the electrolysis process mentioned and shown in (4). Brine contains sodium hydroxide, which is a natural electrolyte. The amount of sodium hydroxide in the electrolyser will be monitored and altered to create the most efficient process of electrolysis possible. Excess sodium hydroxide will be removed from the electrolyser. This sodium hydroxide may be exported or further processed and exported. Additionally, other electrolytes may be added and regulated in the electrolyser.
(8) This invention may contain a pipe input to compress and store hydrogen gas underground, which is produced from methods other than electrolysis. The methods contemplated by this invention as the alternative source of hydrogen gas include, but are not limited to, natural gas reformation (or another type of petroleum reformation) and biological hydrogen production in conjunction with water treatment. The biological process of hydrogen production contemplated in this invention includes, but is not limited to, the use of a biological agent, such as algae, to produce large amounts of hydrogen as a useful byproduct in the process of water treatment.
(9) This invention will contain an air compressor, which will compress hydrogen gas into an underground cavern.
(10) This invention will store compressed hydrogen in an underground cavern. This cavern may be lined and reinforced with concrete and steel both above ground and below ground. The underground storage unit contemplated by this invention may include, but is not limited to, an empty aquifer, an empty natural gas well, an empty salt mine, or other type of empty underground storage cavern.
(11) This invention will contain a safety valve located apart from the main production facility to release and/or burn off hydrogen gas in case of maintenance or catastrophic failure.
(12) This invention will produce electricity when compressed hydrogen is decompressed and released for use. Electricity will be generated by the compressed hydrogen gas turning a turbine, which generates electricity through an electric generator. The electricity can be sent to an electric grid or used for the electrolysis process as shown in (4).
(13) One purpose of the invention is to produce, store, and timely distribute hydrogen gas. This gas will be exported to a hydrogen pipeline or directly to end users.
(14) This invention will generate chlorine gas, which will be compressed and sent through pipes to a water treatment facility. Alternatively, the chlorine gas could be compressed and stored in a storage facility next to the main production facility. The gas could then be sent by truck or train to a location, where the chlorine gas could be used for industrial processes.

1. A system comprising: a brine (which may be ocean, seawater, or estuary) interconnection, an electricity interconnection with an electric grid or electric generation facility, a water filtration or demineralization system, a brine water electrolyser, a gas separation or filtration system, a heat recovery system connected to said electrolyser, a sodium hydroxide recovery system connected to said electrolyser, an interconnection to an alternative hydrogen gas supply, a high pressure underground hydrogen gas storage system, including a hydrogen gas compressor, an underground storage well for hydrogen gas, and electric generation system powered by compressed hydrogen gas turning a turbine during decompression, which can send electricity either to said electrolyser or to an electric grid, a hydrogen gas outlet connected to said underground hydrogen gas storage system, and a system to collect and distribute other gases including, but not limited to, chlorine gas.

2. The electrolyser of claim 1 may be of high pressure or low pressure.

3. The electrolyser of claim 2, further comprising a gas separation system to separate hydrogen gas and chlorine gas from other gases.

4. The electrolyser of claim 2, further comprising a self-contained heat recovery system, which can be used to facilitate and increase the efficiency of electrolysis.

5. The electrolyser of claim 2, further comprising a self-contained electrolyte recovery system. The main electrolyte in brine is sodium hydroxide. This sodium hydroxide may be extracted and either sold or processed further. Additional electrolytes may be added to said electrolyser and recovered as well.

6. The high pressure underground hydrogen gas storage system of claim 1, further comprising an empty petroleum or natural gas well, an empty salt mine, an empty aquifer, or other artificial or natural empty underground well This underground storage system may be reinforced with concrete above and below ground.

7. The high pressure underground hydrogen gas storage system of claim 6, further comprising one or multiple air compressors in combination with one or multiple heat exchangers.

8. The electric generation system powered by the decompression of compressed hydrogen gas of claim 1, generating electricity in a manner known as, “compressed air storage.” This invention claims generation with respect to power generated from decompressing hydrogen gas and not atmospheric air. This invention claims the use of compressed hydrogen gas to turn a turbine to produce electric current from an electric generator by the method of decompressing compressed hydrogen gas.
